(19) United States
(12) Patent Application Publication
(10) Pub. No.: US 2014/0304447 A1
(43) Pub. Date: Oct. 9, 2014

(54) METHOD, SYSTEM AND APPARATUS FOR COMMUNICATING WITH AN ELECTRONIC DEVICE AND A STEREO HOUSING

(71) Applicant: Robert Louis Fils, Los Gatos, CA (US)

(72) Inventor: Robert Louis Fils, Los Gatos, CA (US)

(21) Appl. No.: 14/225,822

(22) Filed: Mar. 26, 2014

Related U.S. Application Data
(63) Continuation-in-part of application No. 13/858,511, filed on Apr. 8, 2013.

(51) Int. Cl. G06F 1/16; G08C 17/02

(52) U.S. Cl. CPC G06F 1/1632; G08C 17/02; G08C 2201/93; G08C 2201/31
USPC 710/303; 340/12.5

(57) ABSTRACT

A remote control for communicating with an electronic device and a stereo housing comprises a microphone, a remote control speaker, a controller, and a video screen that displays visual content based on content of the electronic device and the stereo housing. The visual content is able to comprise song, album, and artist information and caller identification information of a call received by the electronic device. In some embodiments, the remote control speaker plays audio from the electronic device and the audio system. In some embodiments, the remote control is able to divert audio content including phone calls between the remote control speaker and a speaker of the audio system. In some embodiments, the remote control is configured utilize infrared, infrared laser, radio frequency, wireless, WiFi, Bluetooth®, 2.4 Gh and IAP protocols. In some embodiments, the remote control is hermetically sealed from water and environmental intrusion.

### RELATED APPLICATIONS

This patent application is a continuation-in-part of the U.S. patent application Ser. No. 13/858,511, filed on Apr. 8, 2013, and entitled, METHOD, SYSTEM AND APPARATUS FOR COMMUNICATING WITH AN ELECTRONIC DEVICE AND A STEREO HOUSING, which is hereby incorporated by reference in its entirety.

### FIELD OF THE INVENTION

The present invention relates to controlling an electronic device coupled to a docking station or stereo system. More particularly, the present invention relates to remotely controlling an electronic device and a hermetically sealed docking station or stereo system.

### BACKGROUND OF THE INVENTION

Portable digital media players and electronic devices allow consumers to carry their music and other media with them wherever they go. Devices such as the iPod™, iPhone™ and other electronic devices are rapidly gaining popularity. Particularly, it is often desirable for a user to listen to music or use their electronic device in numerous locations, such as in the car, outside, or while performing an activity. In order to enhance the use of the electronic device, it is often connected to an external audio system or docking station. In some instances, a user is able to place the electronic device in one location and communicate with an audio system which is located in a separate location. Alternatively, the electronic device is coupled with a docking station and played through a speaker system of the docking station. However, once the electronic device is coupled with the external audio system or docking station it is difficult to control the electronic device as the user moves around or accomplishes a task.

### SUMMARY OF THE INVENTION

Embodiments of the present invention are directed to an apparatus, system and method for remotely communicating with an electronic device and a hermetically sealed stereo system. The stereo system comprises a housing for removably docking and housing an electronic device and a communication device. The communication device comprises a receiver which is configured for receiving a command signal and a control device which receives a signal from the receiver and sends a signal to one or both of an electronic device operation circuit and a stereo housing operation circuit based upon the signal sent to the receiver. In some embodiments, the command signal sent to the receiver is a voice command. Sending a command signal to the receiver and the communication device enables a user to control one or both of the electronic device and the stereo housing. In some embodiments, the communication device is configured to receive a signal from the electronic device and the stereo housing.

In one aspect, an audio system comprises a stereo housing for removably docking and housing an electronic device and a communication device for communicating with the housing and the electronic device, the communication device comprising a first receiver for receiving a command signal, a second receiver for receiving a display signal, and a control device that receives a signal from the first receiver and the second receiver and sends a signal to one or more of an electronic device operation circuit, a stereo housing operation circuit, and a video screen operation circuit. In some embodiments, the electronic device is completely enclosed within the stereo housing. In some embodiments, the first receiver is a microphone and receives voice command signals for controlling the stereo housing and the electronic device. In some embodiments, the communication device comprises a remote control. In some of these embodiments, the remote control is hermetically sealed from water and environmental intrusion. In some embodiments, the control device sends a wireless signal. In some of these embodiments, the signal comprises one or more of infrared, infrared laser, radio frequency, wireless, WiFi, Bluetooth®, 2.4 Gh and IAP protocol. In some embodiments, the control device sends a signal to the electronic device operation circuit to answer, hang up or make a phone call with the electronic device. In further embodiments, the control device sends a signal to one or more of the electronic device operation circuit and the stereo housing operation circuit to start, stop, pause, or adjust the volume of media being played by the audio system based upon the command signal received by the first receiver. In still further embodiments, the control device sends a signal to the video operation circuit to display visual content based upon the display signal received by the second receiver. In some of these embodiments, the visual content comprises song, album, and artist information. In further embodiments, the visual content comprises caller identification information of a call received by the electronic device. In some embodiments, the video screen operation circuit controls a video screen of the communication device.

In another aspect, a remote control for communicating with an electronic device and a stereo housing comprises a microphone, a remote control speaker, a controller, and a video screen that displays visual content based on content of the electronic device and the stereo housing. In some embodiments, the visual content comprises song, album, and artist information. In further embodiments, the visual content comprises caller identification information of a call received by the electronic device. In some embodiments, the remote control speaker plays audio from the electronic device and the audio system. Particularly, the remote control comprises a switch for diverting audio content between the remote control speaker and a speaker of the audio system. In some embodiments, the audio content comprises a phone call. In some embodiments, the remote control is configured to send and receive a wireless signal comprising one or more of infrared, infrared laser, radio frequency, wireless, WiFi, Bluetooth®, 2.4 Gh and IAP protocol. In some embodiments, the remote control is hermetically sealed from water and environmental intrusion.

In a further aspect, a method of operating an audio system comprises coupling an electronic device with the audio system, sending a signal to one or more of an electronic device operation circuit and a stereo housing operation circuit to operate the audio system and displaying visual content at a remote control based upon the operation of the audio system. In some embodiments, the electronic device is completely enclosed within the housing. In some embodiments, the visual content comprises song, album, and artist information. In further embodiments, the visual content comprises caller identification information from a call received by the electronic device. In some embodiments, the remote control is hermetically sealed from water and environmental intrusion.

### BRIEF DESCRIPTION OF THE DRAWINGS

FIG. 1 illustrates a stereo system in accordance with some embodiments.

FIG. 2 illustrates a schematic view showing the components of a communication system for a stereo housing an electronic device in accordance with some embodiments.

FIG. 3 illustrates a method of remotely operating a stereo housing and an electronic device in accordance with some embodiments.

FIG. 4 illustrates a remote control in communication with a housing unit and an electronic device, in accordance with some embodiments.

FIG. 5 illustrates a schematic view showing the components of a audio system in accordance with some embodiments.

FIG. 6 illustrates a remote control in communication with a housing unit and an electronic device, in accordance with some embodiments.

FIG. 7 illustrates a method of operating an audio system in accordance with some embodiments.

### DETAILED DESCRIPTION OF THE PREFERRED EMBODIMENT

In the following description, numerous details and alternatives are set forth for purpose of explanation. However, one of ordinary skill in the art will realize the invention is able to be practiced without the use of these specific details. Particularly, one of ordinary skill in the art will recognize that some embodiments of the invention are able to be practiced with other electronic systems and components. Throughout the description similar components are similarly marked in order to aid comprehension.

Embodiments of the present invention are directed to an apparatus, system and method for remotely communicating with an electronic device and a stereo system. In some embodiments, the stereo system is hermetically sealed and ingression protection rated. In these embodiments, the stereo system is completely sealed from water and environmental intrusion. The stereo system comprises a housing for removably docking and housing an electronic device and a communication device. The communication device comprises a receiver which is configured for receiving a command signal, and a control device which receives a signal from the receiver and sends a signal to one or both of an electronic device operation circuit and a stereo housing operation circuit based upon the signal sent to the receiver. In some embodiments, the command signal sent to the receiver is a voice command. Sending a command signal to the receiver and the communication device enables a user to control one or both of the electronic device and the stereo housing. In some embodiments, the communication device comprises a remote control. In some embodiments, the remote control is hermetically sealed and ingression protection rated. In these embodiments, the remote control is completely sealed from water and environmental intrusion.

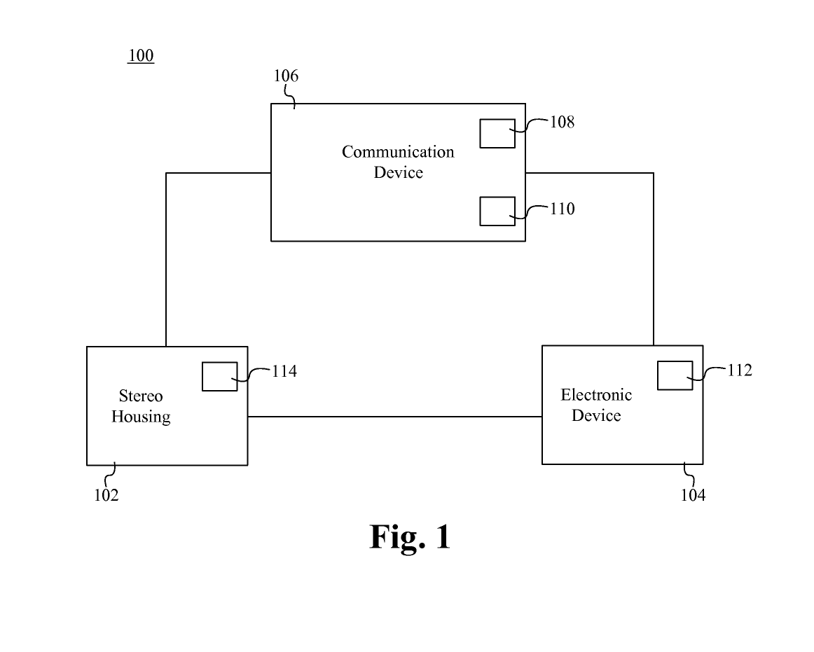

FIG. 1 illustrates a stereo system in accordance with some embodiments. The system 100 comprises a stereo housing 102 for removably coupling with an electronic device 104 and a communication device 106. In some embodiments, the stereo housing 102 comprises an apparatus for housing a removable electronic device such as described in the co-owned U.S. Pat. No. 7,831,756 and the co-owned U.S. patent application Ser. No. 12/915,967, and entitled “Docking Station for an Electronic Device”, both of which are hereby incorporated by reference. In these embodiments, when the electronic device 104 is coupled with the stereo housing 102, the electronic device 104 is docked within and completely enclosed within an enclosure of the stereo housing 102. Alternatively, in some embodiments, the electronic device 104 is wirelessly coupled with the stereo housing 102. In some embodiments the electronic device 104 is a portable digital media device such as an iPod™, Palm™, Zen™, Zune™, or other digital media device such as a tablet, MP3 player or music phone. Particularly, the electronic device 104 is able to comprise any appropriate electronic media player as known in the art. The stereo housing 102 is able to be coupled to one or more of an amplifier, a receiver and speakers in order to power the system. In some embodiments, the system 100 is ingress protection rated and is designed for use in an aquatic environment such as a boat or a spa. In some embodiments, the stereo housing 102 comprises a display screen and is configured to display video files.

In some embodiments, the communication device 106 comprises a receiver 108 for receiving a command signal and a control device 110 for controlling the device 106. The receiver 108 receives a command signal and sends a signal to the control device 110 based upon the command signal. The control device 110 processes the signal from the receiver 106 and sends a sends a signal to one or both of an electronic device operation circuit 212 and a stereo housing operation circuit 214.

As shown within FIG. 1, the two the communication device 106 is coupled to the stereo housing 102 and the electronic device 104. In some embodiments, the communication device 106 is a component of the stereo housing 102. In these embodiments, the device 106 is able to communicate with the electronic device 104 in a wired or wireless manner depending upon the connection of the electronic device 104 with the stereo housing 102. For example, if the electronic device 104 is docked with the stereo housing 102 then the device 106 is able to communicate with the electronic device 104 through the electronic device's 104 docking connection with the housing 102. Alternatively, in some embodiments, the communication device 106 communicates with the electronic device 104 in a wireless manner. Particularly, the communication device 106 is able to communicate with the electronic device 104 independent of the electronic device's 104 connection with the stereo housing 102. In further embodiments, the communication device 106 is separatable from the stereo housing 102. For example, in some embodiments, the device 106 comprises a remote control for controlling the stereo housing 102 and the electronic device 104. In some embodiments, the remote control is hermetically sealed and ingression protection rated. In these embodiments, the remote control is completely sealed from water and environmental intrusion. In some embodiments, the communication device 106 is able to receive one or more signals from the electronic device 104 and the stereo housing 102. For example, in some embodiments, the communication device 106 comprises a speaker and is able to play media from the stereo housing 102 and the electronic device 104 or answer and talk on a phone call received by the electronic device 106.

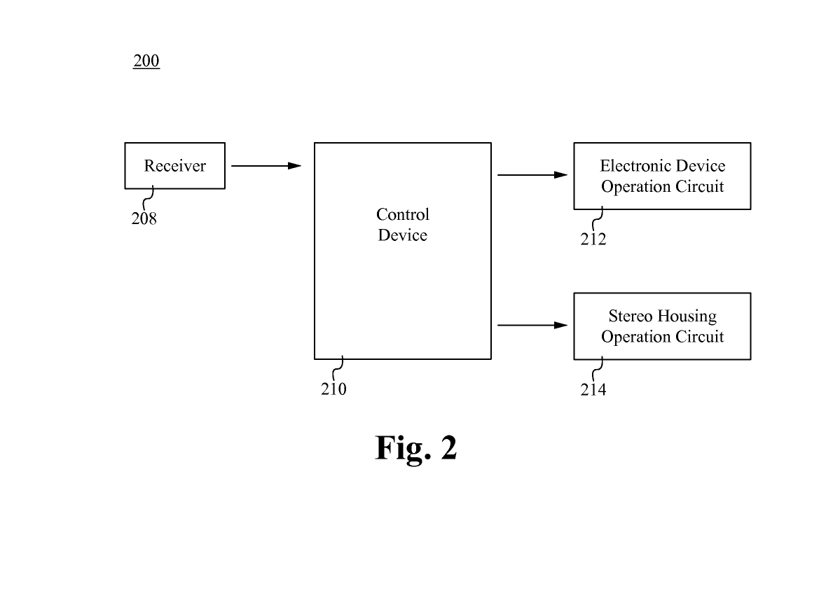

FIG. 2 illustrates a communication device for a stereo housing an electronic device in accordance with some embodiments. In some embodiments, the communication device 200 is for a hermetically sealed stereo housing or electronic docking station such as described above.

As shown in FIG. 2, the communication device 200 comprises a receiver 208, a control device 210, an electronic device operation circuit 212, and a stereo housing operation circuit 214. The receiver 208 receives a command signal and sends a signal to the control device 210 based upon the command signal. The control device 210 processes the signal from the receiver 208 and sends a signal to one or both of the electronic device operation circuit 212 and the stereo housing operation circuit 214. The electronic device operation circuit 212 operates an electronic device based upon the signal from the control device 210 and the stereo housing operation circuit 214 operates a stereo housing based upon the signal received from the control device 210. For example, in some embodiments, the receiver 208 receives a command to adjust the volume of a speaker system connected to the stereo housing. In response, the receiver 208 sends a signal to the control device 210 which processes the signal from the receiver 208 and sends a signal to the stereo housing operation circuit 214 to adjust the volume of the speaker system to a desired level. In some embodiments, the receiver 208 receives a signal to change the media that is playing through the stereo housing. In response, the receiver 208 sends a signal to the control device 210 which processes the signal from the receiver 208 and sends a signal to the stereo housing operation circuit 214 to change the media that is playing through the stereo housing. Particularly, the receiver 208 is able to receive and the control device 210 is able to send any appropriate control signal to the stereo housing operation circuit 214 as known in the art. For example, in some embodiments, the control device 210 sends a signal to the stereo housing to start, stop, pause, power up, or power down the stereo housing.

In further embodiments, the receiver 208 receives a command to operate the electronic device. For example, in some embodiments, the receiver 208 receives a command to answer or dial a phone call. In response, the receiver 208 sends a signal to the control device 210 which processes the signal from the receiver 208 and sends a signal to the electronic device operation circuit 212 to answer or dial the phone call. Particularly, when a user wishes to use the electronic device, the user is able to send a signal to the receiver to operate the electronic device in a desired manner using the components of the stereo housing.

In still further embodiments, the receiver 208 receives a command to operate the electronic device and the housing. For example, in some embodiments, the receiver 208 receives a command to power on or power off the electronic device and the stereo housing. In response, the receiver 208 sends a signal to the control device 210 which processes the signal from the receiver 208 and sends a signal to the electronic device operation circuit 212 and the operation circuit 214 to power on or power off the electronic device and the stereo housing.

In some embodiments, the receiver 208 is a microphone and is configured for receiving voice commands. Alternatively, in some embodiments, the receiver 208 comprises on or more push buttons which are pressed in order to control an aspect of one or both of the stereo housing and the electronic device. As described above, in some embodiments, the communication device is a component of the stereo housing. Alternatively, in some embodiments, the device is a component of a remote control for controlling the stereo housing and the electronic device.

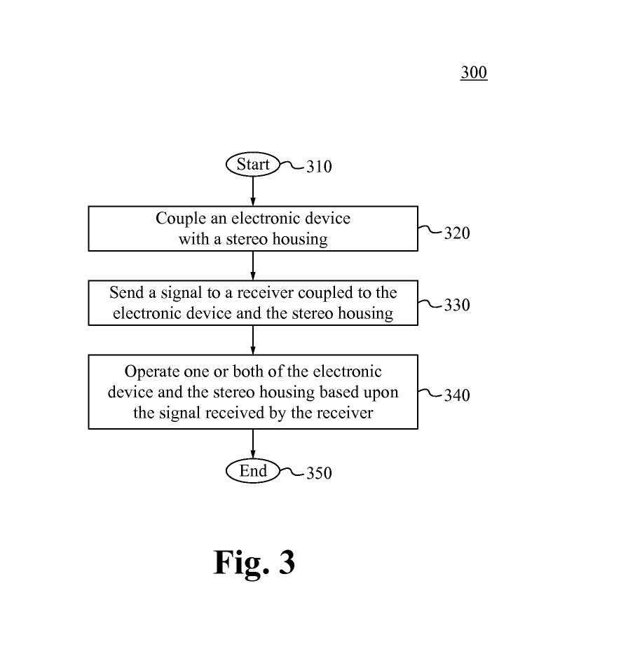

FIG. 3 illustrates a method of remote controlling an electronic device and stereo housing, in accordance with some embodiments. The method starts in the step 310. In the step 320, an electronic device is coupled with a stereo housing. In some embodiments, the electronic device is inserted into the stereo housing and completely enclosed within the housing. In some embodiments, the stereo housing is hermetically sealed and ingress protection rated. Particularly, the stereo housing is coupled to one or more of an amplifier, a stereo receiver and one or more speakers in order to play media located on the electronic device. Then, in the step 330, a signal is sent to a receiver coupled to the electronic device and the stereo housing. As described above, the receiver sends a signal to control device which process the signal from the receiver and sends a signal to one or both of an electronic device operation circuit and a stereo housing circuit. In the step 340, the electronic device, and/or the stereo housing is operated based upon the signal received by the receiver. In some embodiments, the receiver is a microphone and the signal is a voice command. Alternatively, in some embodiments the receiver comprises a remote control. In some embodiments, a signal is received at the remote control based upon the signal sent to one or both of the electronic device operation circuit and the stereo housing circuit. In some embodiments, the remote control is hermetically sealed and ingression protection rated. In these embodiments, the remote control is completely sealed from water and environmental intrusion.

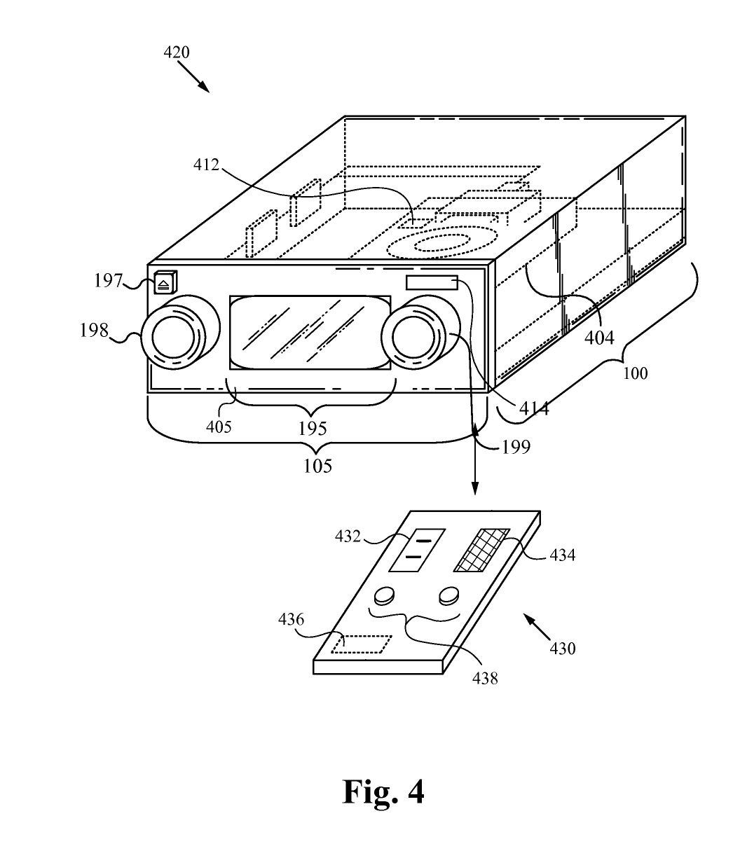

Referring now to FIG. 4, a remote control is shown in communication with a housing unit and an electronic device, in accordance with some embodiments. As shown in FIG. 4, an electronic device 404 has been removably coupled with a housing unit 420. In some embodiments, the electronic device 404 is completely enclosed within the housing unit 420 when it is coupled with the housing unit 420. In some embodiments, to connect the electronic device 404 with the housing unit 420, the user moves a controller interface 405 to an open position. The user then inserts the electronic device 404 into the housing unit 420 and couples the electronic device 404 with a device-housing connector inside the housing unit 420. The user then moves the controller interface 405 to a closed position, forming a waterproof enclosure housing the electronic device 404 within. In some embodiments, the controller interface 405 allows the user to operate the electronic device 404, now safely enclosed within the housing unit 420, and play content, such as music or other audio or video, through a connected audio system. Once the electronic device 404 is coupled within the housing unit 420, the user is able to access and control the functions of the electronic device 404 and the housing unit 420 by using the remote control 430. In some embodiments, the remote control 430 communicates with the electronic device 404 and the housing unit 420 with a wireless technology such as IEEE 802.11, Bluetooth®, Radio Frequency (RF) or any other appropriate wireless methodology.

The remote control 430 comprises a microphone 432 for receiving a voice command or other communication, a controller 436 and a speaker 434. In some embodiments, the remote control 430 is hermetically sealed and ingression protection rated. In these embodiments, the remote control 430 is completely sealed from water and environmental intrusion. In some embodiments, the microphone 432 receives a voice command or other communication from the user and sends a signal to the controller 436. The controller 436 processes the signal from the microphone 432 and sends a signal to one or both of the electronic device operation circuit 412 and the housing unit operation circuit 414. The electronic device operation circuit 412 operates an electronic device based upon the signal from the controller 436 and the housing unit operation circuit 414 operates the housing unit based upon the signal received from the controller 436.

For example, in some embodiments, the microphone 432 receives a voice command to adjust the volume of a speaker system connected to the housing unit 420. In response, the microphone 432 sends a signal to the controller 436 which processes the signal from the microphone 432 and sends a signal to the housing unit operation circuit 414 to adjust the volume of a speaker system coupled to the housing unit 420 to a desired level. In some embodiments, the microphone 432 receives a signal to change the media that is playing through the housing unit 420. In response, the microphone 432 sends a signal to the controller 436 which processes the signal from the microphone 432 and sends a signal to the housing unit operation circuit 414 to change the media that is playing through the stereo housing. Particularly, the microphone 432 is able to receive and the controller 436 is able to send any appropriate control signal to the housing unit operation circuit 414 as known in the art. For example, in some embodiments, the controller 436 sends a signal to the housing unit 420 to start, stop, pause, power up, or power down. In some embodiments, the media of the housing unit 420 is able to be played through the speaker 434. For example, a user is able to utilize the microphone 432 in order to send a voice command in order to play media through the speaker 434 of the remote control 430.

In further embodiments, the microphone 432 receives a command to operate the electronic device 404. For example, in some embodiments, the microphone 432 receives a command to answer or dial a phone call. In response, the microphone 432 sends a signal to the controller 436 which processes the signal from the microphone 432 and sends a signal to the electronic device operation circuit 412 to answer or dial the phone call. Particularly, when a user wishes to use the electronic device, the user is able to send a signal to the receiver to operate the electronic device 404 in a desired manner using the components of the stereo housing. Alternatively, in some embodiments, the phone call is received through the speaker 434 of the remote control 430. For example, a user is able to utilize the microphone 432 in order to send a voice command in order to receive a phone call through the speaker 434 of the remote control 430.

In still further embodiments, the microphone 432 receives a command to operate the electronic device and the housing. For example, in some embodiments, the microphone 432 receives a command to power on or power off the electronic device 404 and the housing unit 420. In response, the microphone 432 sends a signal to the controller 436 which processes the signal from the microphone 432 and sends a signal to the electronic device operation circuit 412 and the housing unit operation circuit 414 to power on or power off the electronic device 404 and the housing unit 420.

As shown in FIG. 4, in some embodiments, the remote control 430 comprises one or more buttons 438. The one or more buttons 438 are able to be used in order to send control signals to one or both of the electronic device 404 and the housing unit 420.

As described above, in some embodiments, the remote control 430 is used as a two-way remote control. In these embodiments, the remote control 430 sends signals to the electronic device 404 and the housing unit 420 and also receives signals from the electronic device 404 and the housing unit 420. Alternatively, in some embodiments, the remote control 430 is used to communicate signals to the electronic device 404 and the housing unit 420 in a one-way manner.

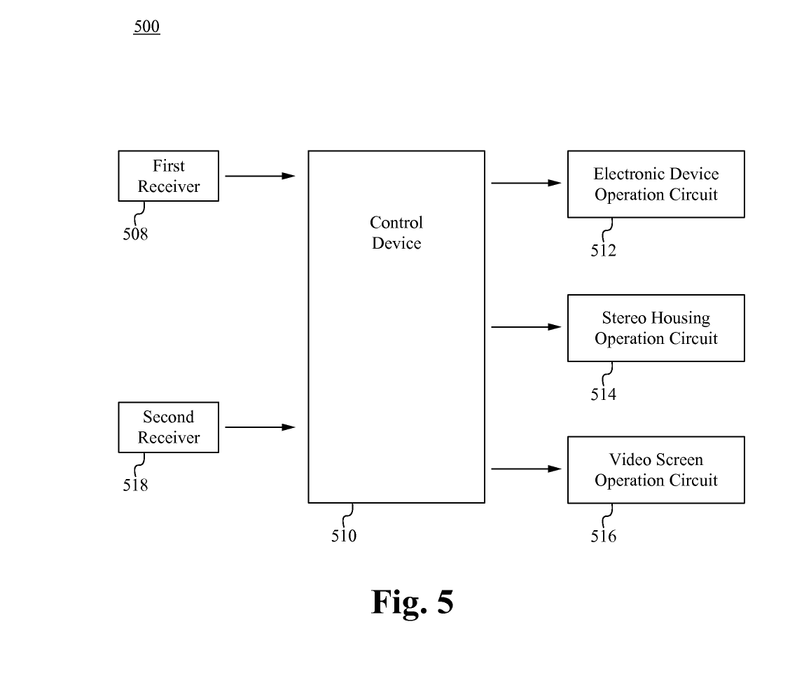

Referring now to FIG. 5, a communication device is depicted therein. The communication device 500 is configured to be used with an electronic device and stereo system and/or audio system comprising a stereo housing such as described above and below.

The communication device 500 is configured to communicate with the electronic device and the stereo housing. The communication device 500 comprises a first receiver 508, a second receiver 518, a control device 510, an electronic device operation circuit 512, a stereo housing operation circuit 514, and a video screen operation circuit 516. In some embodiments, the first receiver 508, the second receiver 518, the control device 510, and the video operation circuit 516 are components of a remote control for controlling the electronic device and the stereo housing. In some embodiments, the remote control is hermetically sealed from water and environmental intrusion.

The first receiver 508 receives a command signal and sends a signal to the control device 510 based upon the command signal. The control device 510 processes the signal from the first receiver 508 and sends a signal to one or more of the electronic device operation circuit 512 and the stereo housing operation circuit 514. As described above, the electronic device operation circuit 512 operates an electronic device based upon the signal from the control device 510 and the stereo housing operation circuit 514 operates a stereo housing based upon the signal from the control device 510.

For example, as described above, in some embodiments, the first receiver 508 receives a command to adjust the volume of a speaker system connected to the stereo housing. In response, the first receiver 508 sends a signal to the control device 510 which processes the signal from the first receiver 508 and sends a signal to the stereo housing operation circuit 514 to adjust the volume of the speaker system to a desired level. In some embodiments, the first receiver 508 receives a signal to change the media that is playing through the stereo housing. In response, the first receiver 508 sends a signal to the control device 510 which processes the signal from the first receiver 508 and sends a signal to the stereo housing operation circuit 514 to change the media that is playing through the stereo housing. Particularly, the first receiver 508 is able to receive and the control device 510 is able to send any appropriate control signal to the stereo housing operation circuit 514 as known in the art. For example, in some embodiments, the control device 510 sends a signal to the stereo housing to start, stop, pause, power up, or power down the stereo housing.

In further embodiments, the first receiver 508 receives a command to operate the electronic device. For example, in some embodiments, the first receiver 508 receives a command to answer or dial a phone call. In response, the first receiver 508 sends a signal to the control device 510 which processes the signal from the first receiver 508 and sends a signal to the electronic device operation circuit 512 to answer or dial the phone call. Particularly, when a user wishes to use the electronic device, the user is able to send a signal to the receiver to operate the electronic device in a desired manner using the components of the stereo housing.

In still further embodiments, the first receiver 508 receives a command to operate the electronic device and the housing. For example, in some embodiments, the first receiver 508 receives a command to power on or power off the electronic device and the stereo housing. In response, the first receiver 508 sends a signal to the control device 510 which processes the signal from the first receiver 508 and sends a signal to the electronic device operation circuit 512 and the operation circuit 514 to power on or power off the electronic device and the stereo housing.

In some embodiments, the first receiver 508 is a microphone and is configured for receiving voice commands. Alternatively, in some embodiments, the first receiver 508 comprises on or more push buttons which are pressed in order to control an aspect of one or both of the stereo housing and the electronic device. As described above, in some embodiments, the communication device is a component of the stereo housing. Alternatively, in some embodiments, the device is a component of a remote control for controlling the stereo housing and the electronic device.

The second receiver 518 receives a display signal and sends a signal to the control device 510 based upon the display signal. The control device 510 processes the signal from the second receiver 518 and sends a signal to the video screen operation circuit 516. The video operation circuit 516 operates a video screen based upon a signal from the control device 510. For example, in some embodiments, the video screen is an LCD screen and is a component of the communication device 500. The video screen displays visual content such as song, album, and artist information of the based upon the media that is being played by the electronic device and the stereo housing. Alternatively, in some embodiment, the video screen displays caller identification information of the call received by the electronic device.

In some embodiments, the electronic device is completely enclosed within the stereo housing. Particularly, the communication device 500 is able to utilize a wired or a wireless signal in order to control and receive information from the stereo housing and the electronic device. In some embodiments, the wireless signal used by the communication device 500 comprises one or more of infrared, laser, radio frequency, WiFi, Bluetooth®, and 2.4 Gh. In some embodiments, the communication device 500 utilizes the IAP protocol.

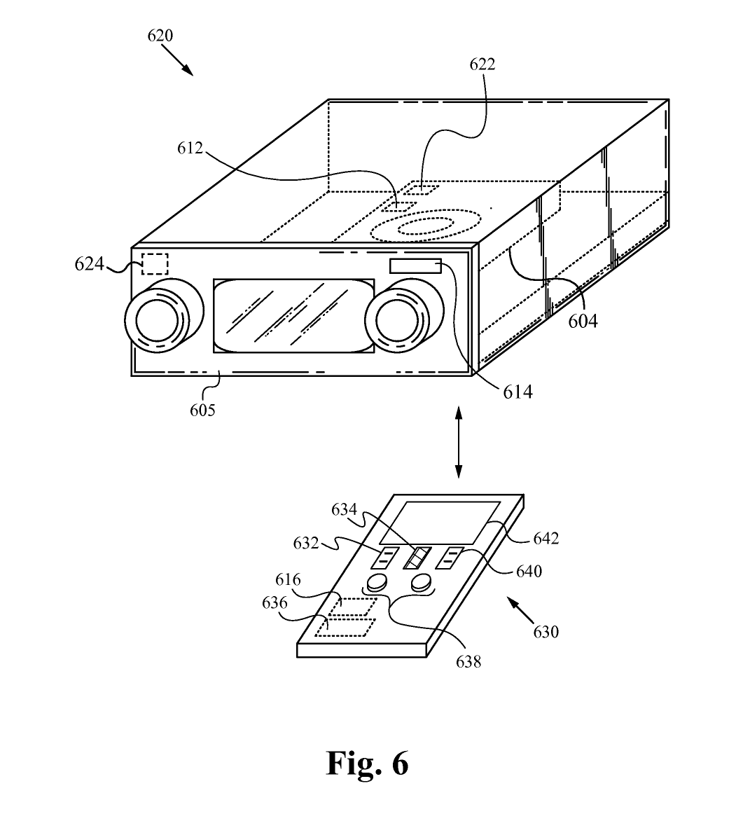

Referring now to FIG. 6, a remote control for communicating with an electronic device and a stereo housing, such as described above, is depicted therein. The remote control 630 is shown in communication with an electronic device 604 and a stereo housing 620, such as shown within FIG. 4. As shown in FIG. 6, an electronic device 604 has been removably coupled with a housing unit 620. In some embodiments, the electronic device 604 is completely enclosed within the housing unit 620 when it is coupled with the housing unit 620. In some embodiments, to connect the electronic device 604 with the housing unit 620, the user moves a controller interface 605 to an open position. The user then inserts the electronic device 604 into the housing unit 620 and couples the electronic device 604 with a device-housing connector inside the housing unit 620. The user then moves the controller interface 605 to a closed position, forming a waterproof enclosure housing the electronic device 604 within. In some embodiments, the controller interface 605 allows the user to operate the electronic device 604, now safely enclosed within the housing unit 620, and play content, such as music or other audio or video, through a connected audio system. Once the electronic device 604 is coupled within the housing unit 620, the user is able to access and control the functions of the electronic device 604 and the housing unit 620 by using the remote control 630. In some embodiments, the remote control 630 communicates with the electronic device 604 and the housing unit 620 with a wireless technology such as IEEE 802.11, Bluetooth®, Radio Frequency (RF), 2.6 Gh or any other appropriate wireless methodology. In some embodiments, the remote control 630 communicates with the electronic device 604 and the housing unit 620 using the IAP protocol.

The remote control 630 works similarly to the remote control 430 such as described above, and comprises a microphone 632 for receiving a voice command or other communication, a remote control speaker 634, a controller 636, a video screen operation circuit 616, and a video screen 642 that displays visual content received from the electronic device 604 and the stereo housing 620. Although a video screen 642 is shown in FIG. 6, in some embodiments, there is no video screen 642 similar to as shown in FIG. 4. In some embodiments, the remote control 630 is hermetically sealed and ingression protection rated. In these embodiments, the remote control 630 is completely sealed from water and environmental intrusion. As shown in FIG. 6, in some embodiments, the remote control 630 comprises one or more buttons 638. The one or more buttons 638 are able to be used in order to send control signals to one or both of the electronic device 604 and the housing unit 620. As described above, in some embodiments, the remote control 630 is used as a two-way remote control. In these embodiments, the remote control 630 sends signals to the electronic device 604 and the housing unit 620 and also receives signals from the electronic device 604 and the housing unit 620. Alternatively, in some embodiments, the remote control 630 is used to communicate signals to the electronic device 604 and the housing unit 620 in a one-way manner. In some embodiments, the remote control 630 comprises replaceable and/or rechargeable batteries.

The microphone 632 receives a voice command or other communication from the user and sends a signal to the controller 636. The controller 636 processes the signal from the microphone 632 and sends a signal to one or both of the electronic device operation circuit 612 and the housing unit operation circuit 614. The electronic device operation circuit 612 operates an electronic device based upon the signal from the controller 636 and the housing unit operation circuit 614 operates the housing unit based upon the signal received from the controller 636. For example, in some embodiments, the microphone 632 receives a voice command to adjust the volume of a speaker system connected to the housing unit 620. In response, the microphone 632 sends a signal to the controller 636 which processes the signal from the microphone 632 and sends a signal to the housing unit operation circuit 614 to adjust the volume of a speaker system coupled to the housing unit 620 to a desired level. In some embodiments, the microphone 632 receives a signal to change the media that is playing through the housing unit 620. In response, the microphone 632 sends a signal to the controller 636 which processes the signal from the microphone 632 and sends a signal to the housing unit operation circuit housing unit operation circuit 614 to change the media that is playing through the stereo housing 620. Particularly, the microphone 632 is able to receive and the controller 636 is able to send any appropriate control signal to the housing unit operation circuit 614 as known in the art. For example, in some embodiments, the controller 636 sends a signal to the housing unit 620 to start, stop, pause, power up, or power down. In some embodiments, the media of the housing unit 620 is able to be played through the speaker 634. For example, a user is able to utilize the microphone 632 in order to send a voice command in order to play media through the speaker 634 of the remote control 630.

In further embodiments, the microphone 632 receives a command to operate the electronic device 604. For example, in some embodiments, the microphone 632 receives a command to answer or dial a phone call. In response, the microphone 632 sends a signal to the controller 636 which processes the signal from the microphone 632 and sends a signal to the electronic device operation circuit 612 to answer or dial the phone call. In some embodiments, the phone call is received through the speaker 634 of the remote control 630. Alternatively, in some embodiments, the phone call is able to be played through one or more speakers connected to the stereo housing 620. Particularly, a switch 640 is able to be used to transfer the phone call between the speaker 634 of the remote control 630 and one or more speakers of the stereo housing 620. In this manner, a user is able to participate in a conversation using an audio system or privately through the remote 630. In some embodiments, the audio from the electronic device 604 is received by the remote 630 through a wireless connection and transferred to the one or more speakers of the stereo housing 620 using the same or different wireless connection.

Using the microphone 632 the user is able to make and receive calls and operate the electronic device 604 simply by speaking into the microphone 632. For example, a user may say “call mom” or other voice command into the microphone 632 and the electronic device 604 initiates a phone call to “mom.” Additionally, in some embodiments, a user speaks voice commands into the microphone 632 so that the electronic device 604 initiates another operation. For example, a user may ask “what restaurants are in the area.” In response, the microphone 632 sends a signal to the controller 636 which processes the signal from the microphone 632 and sends a signal to the electronic device operation circuit 612 to look up nearby restaurants and play the answer through the speaker 634 of the remote control 630 or stereo housing 620, such as described above, or display the answer on the video screen 642.

In still further embodiments, the microphone 632 receives a command to operate the electronic device and the housing. For example, in some embodiments, the microphone 632 receives a command to power on or power off the electronic device 604 and the housing unit 620. In response, the microphone 632 sends a signal to the controller 636 which processes the signal from the microphone 632 and sends a signal to the electronic device operation circuit 612 and the housing unit operation circuit 614 to power on or power off the electronic device 604 and the housing unit 620.

The video screen 642 displays visual content received from the electronic device 604 and the stereo housing 620. In some embodiments, the video screen is an LCD screen. Particularly, the video operation circuit 616 operates the video screen 642 based upon a signal from the controller 636. For example, in some embodiments, the controller 636 receives a signal from a transmitter 622 of the electronic device 604 based upon the media being played by the electronic device 604. The controller 636 processes the signal from the transmitter 622 and sends a signal to the video screen operation circuit 616 to display visual content. In some embodiments, the transmitter 622 sends a signal to the video operation circuit 616 based upon the music being played by the electronic device 604 and the video screen 642 displays one or more of the album, artist, and song information correlated to the music being played. In some embodiments, if the electronic device 604 has received or is making a telephone call, the transmitter 622 sends a signal to the video operation circuit 616 and the video screen displays the caller identification information. Alternatively, or in conjunction, the controller 616 receives a signal from a transmitter 624 of the stereo housing 620 based upon the media being played through the stereo housing 620 and a phone call being played through one or more speakers of the stereo housing. The controller 636 processes the signal from the transmitter 624 and sends a signal to the video screen operation circuit 616 to display the visual content.

In some embodiments, the remote control 630 is configured to download information based upon a signal or command received by the microphone 632. For example, the microphone 632 receives a command to play a certain song or album and the corresponding information is sent to the video screen operation circuit 616 and the video screen 642 displays the information.

Additionally, although the video screen 642 is shown as a component of the larger controller 630. In some embodiments, the video screen 642 comprises a touch screen and the remaining components are contained with the touch screen controller.

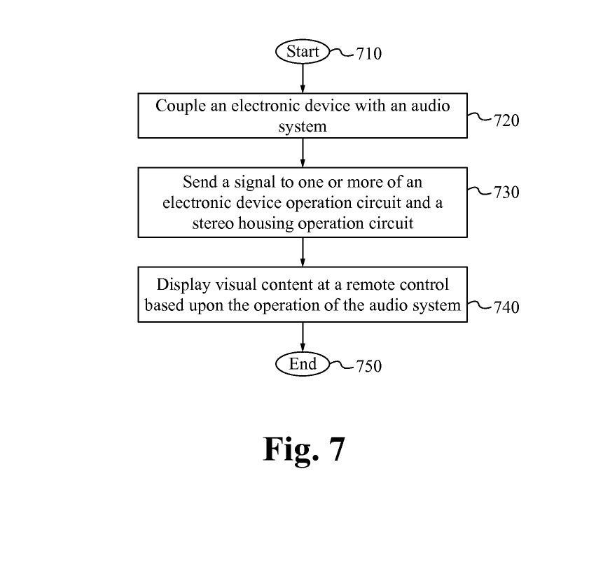

FIG. 7 illustrates a method of operating an audio system. The method begins in the step 710. In the step 720, an electronic device is coupled with an audio system. In some embodiments, the electronic device is inserted into the stereo housing and completely enclosed within the housing. In some embodiments, the stereo housing is hermetically sealed and ingress protection rated. Particularly, the stereo housing is coupled to one or more of an amplifier, a stereo receiver and one or more speakers in order to play media located on the electronic device. In the step 730, a signal is sent to one or more of an electronic device operation circuit and a stereo housing operation circuit to operate one or more of the electronic device and the stereo housing, such as described above. In some embodiments, the signal is one or more of infrared, laser, radio frequency, WiFi, Bluetooth®, and 2.4 Gh. In some embodiments, the signal utilizes the IAP protocol. Then, in the step 740 visual content is displayed at a remote control based upon the operation of the audio system. The video screen displays visual content such as song, album, and artist information of the based upon the media that is being played by the electronic device and the stereo housing. Alternatively, in some embodiment, the video screen displays caller identification information of the call received by the electronic device. Then, in the step 750, the method ends.

The present invention provides an easy and convenient way to play and control an electronic device and stereo housing as part of an audio system. Particularly, a user is easily able to play and control the electronic device while it is coupled with the stereo housing and stored in a convenient and secure location. In some embodiments, the electronic device is substantially hermetically sealed within the audio system such that a user is able to control the device in a wet environment such as a spa or boat with a waterproof remote control and without fear of damaging the audio system or the electronic device. Consequently, the user is able to enjoy use of the electronic device without worrying that the device may become damaged by water or environmental intrusion. Alternatively, in some embodiments, a user is able to couple the electronic device with an audio system and use a remote control in order to control the audio system and the electronic device in an indoor setting. The present invention enables a user to conveniently utilize an electronic device and audio system in many different environmental settings.

Additionally, a controller enables information to be displayed at a remote location corresponding to the media being played by the electronic device coupled with the stereo housing. Particularly, a video screen is able to display album, song, and artist information directly to the user holding the remote control. Additionally, a user is able to view caller identification information corresponding to a call received by an electronic device as well as transfer the call between the remote control and the stereo housing. Accordingly, the stereo system and remote control described herein has numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

What is claimed is:

1. An audio system comprising:
a. a stereo housing for removably docking and housing an electronic device; and
b. a communication device for communicating with the housing and the electronic device, the communication device comprising:
i. a first receiver for receiving a command signal;
ii. a second receiver for receiving a display signal; and
iii. a control device that receives a signal from the first receiver and the second receiver and sends a signal to one or more of an electronic device operation circuit, a stereo housing operation circuit, and a video screen operation circuit.

2. The audio system of claim 1 wherein the electronic device is completely enclosed within the stereo housing.

3. The audio system of claim 1 wherein the first receiver is a microphone and receives voice command signals for controlling the stereo housing and the electronic device.

4. The audio system of claim 1 wherein the communication device comprises a remote control.

5. The audio system of claim 4 wherein the remote control is hermetically sealed from water and environmental intrusion.

6. The audio system of claim 1 wherein the control device sends a wireless signal.

7. The audio system of claim 6 wherein the signal comprises one or more of infrared, infrared laser, radio frequency, wireless, WiFi, Bluetooth®, 2.4 Gh, and IAP protocol.

8. The audio system of claim 1 wherein the control device sends a signal to the electronic device operation circuit to answer, hang up or make a phone call with the electronic device.

9. The audio system of claim 1 wherein the control device sends a signal to one or more of the electronic device operation circuit and the stereo housing operation circuit to start, stop, pause, or adjust the volume of media being played by the audio system based upon the command signal received by the first receiver.

10. The audio system of claim 1 where in the control device sends a signal to the video operation circuit to display visual content based upon the display signal received by the second receiver.

11. The audio system of claim 10 wherein the visual content comprises song, album, and artist information.

12. The audio system of claim 10 wherein the visual content comprises caller identification information of a call received by the electronic device.

13. The audio system of claim 1 wherein the video screen operation circuit controls a video screen of the communication device.

14. A remote control for communicating with an electronic device and a stereo housing comprising:
a. a microphone;
b. a remote control speaker;
c. a controller; and
d. a video screen that displays visual content video screen that displays visual content based on content of the electronic device and the stereo housing.

15. The remote control of claim 14 wherein the visual content comprises song, album, and artist information.

16. The remote control of claim 14 wherein the visual content comprises caller identification information of a call received by the electronic device.

17. The remote control of claim 14 wherein the remote control speaker plays audio from the electronic device and the audio system.

18. The remote control of claim 17 wherein the remote control comprises a switch for diverting audio content between the remote control speaker and a speaker of the audio system.

19. The remote control of claim 18 wherein the audio content comprises a phone call.

20. The remote control of claim 14 wherein the remote control is configured to send and receive a wireless signal comprising one or more of infrared, infrared laser, radio frequency, wireless, WiFi, Bluetooth®, 2.4 Gh, and IAP protocol.

21. The remote control of claim 14 wherein the remote control is hermetically sealed from water and environmental intrusion.

22. A method of operating an audio system comprising:
a. coupling an electronic device with the audio system;
b. sending a signal to one or more of an electronic device operation circuit and a stereo housing operation circuit to operate the audio system; and
c. displaying visual content at a remote control based upon the operation of the audio system.

23. The method of claim 22 wherein the electronic device is completely enclosed within the housing.

24. The method of claim 22 wherein the visual content comprises song, album, and artist information.

25. The method of claim 22 wherein the visual content comprises caller identification information from a call received by the electronic device.

26. The method of claim 22 wherein the remote control is hermetically sealed from water and environmental intrusion.
